(19) United States
(12) Patent Application Publication
(10) Pub. No.: US 2008/0255991 A1
(43) Pub. Date: Oct. 16, 2008

(54) Payment System and a Realizing Method Thereof

(75) Inventor: Lin Wang, Guangdong Province (CN)

Correspondence Address: WOLF GREENFIELD & SACKS, P.C., 600 ATLANTIC AVENUE, BOSTON, MA, 02210-2206, US

(73) Assignee: Huawiei Technologies Co., Ltd., Shenzhen, Guangdong Province (CN)

(21) Appl. No.: 11/793,896

(22) PCT Filed: Dec. 8, 2005
(86) PCT No.: PCT/CN05/02122

§ 371 Date: Oct. 29, 2007

(30) Foreign Application Priority Data
Dec. 24, 2004 (CN) 2004/10102530.3

(51) Int. Cl. G06Q 20/00

(52) U.S. Cl. 705/42; 705/35

(57) ABSTRACT

A payment system, including: a payment unit, a gateway connecting to the payment unit, an intelligent peripheral and a service management point; the payment unit stores the data of users, the data of merchants and goods. The system authenticates a transaction request issued by the user using the data, and sends the transaction request passing through the authorization to the merchant; it also authenticates a payment request issued by the merchant and processes the payment service; the gateway and the intelligent peripheral provide modes of accessing the payment unit; the service management point provides a management interface and manages the user data in the payment unit according to commands received from the management interface. The invention also discloses a mobile communication payment method.

### FIELD OF THE INVENTION

The present invention relates to payment technology in communication field, and particularly to a system and an implementing method for payment.

### BACKGROUND OF THE INVENTION

With the popularization of mobile phones, mobile payment with the mobility and uniqueness of mobile phones becomes a new service. In the mobile payment service, as a most important role in the mobile payment value chain, the Mobile Payment Service Center (MPSC) directly determines the success of the mobile payment service.

The existing mobile payment is generally carried out by means of SMS message, and the main process is as follows:

1. A mobile phone user accesses a communication network by means of SMS message and sends a transaction request to a transaction center. The information carried in the transaction request includes a mobile phone number, a bank code, a payment password, a payment amount, and a Point-Of-Sale (POS) terminal number;

2. The transaction center authenticates the information carried in the transaction request, such as the mobile phone number, the bank code, and the payment password, etc.;

3. After the transaction request passes through the authentication, the transaction center establishes a connection with a bank corresponding to the bank code, deducts the payment amount, and does a payment transaction; and

4. The bank or the transaction center establishes a connection with the POS terminal, displays a deduction amount and prints a receipt.

Though mobile payment can be implemented in the above manner, there are disadvantages as follows:

The system is actually a deduction system, which is responsible for deducting from an account and can not process other services;

The modes of service applications are limited; in this case, the user can not access by means of Wireless Application Protocol ( WAP) and WEB, etc.; and

The user can not interact with the merchant (or Service Provider (SP)); the required payment amount is subject to the input of the user's terminal without any payment confirmation; therefore the accuracy and the reliability of the payment are poor.

### SUMMARY OF THE INVENTION

Embodiments of the present invention provide a system and an implementing method for payment, which can enrich the user access modes and the service processing and improve the accuracy and the reliability of payment.

A payment system according to an embodiment of the invention, including: a payment unit, adapted for authenticating a transaction request issued by a user, sending the transaction request passing through the authentication to a merchant, authenticating a payment request issued by the merchant and processing payment service; a gateway, connected with the payment unit and adapted for accessing the payment unit by the user and the merchant.

A method for implementing mobile communication payment according to an embodiment of the invention, including: receiving, by a payment unit, a transaction request containing goods transaction content from a user; authenticating the transaction request and sending the transaction request to a merchant after the request passes through the authentication; receiving a payment request issued by the merchant according to the goods transaction content in the transaction request; authenticating the payment request, requesting the user to confirm the payment request after the payment request passes through the authentication, and deducting from an account of the user upon receiving a confirmation of permitting the payment from the user.

### BRIEF DESCRIPTION OF THE DRAWINGS

FIG. 1A is a structural diagram of a mobile payment system according to an embodiment of the present invention;

FIG. 1B is a structural diagram of a payment unit according to an embodiment of the present invention;

FIG. 2 is a flow chart of a payment transaction according to an embodiment of the present invention;

FIG. 3 is a flow chart of distributing premium by a merchant according to an embodiment of the present invention;

FIG. 4 is a flow chart of refunding by a merchant according to an embodiment of the present invention;

FIG. 5 is a flow chart of reversing by a merchant according to an embodiment of the present invention;

FIG. 6 is a flow chart of establishing a goods ordering relationship according to an embodiment of the present invention;

FIG. 7 is a flow chart of canceling a goods ordering relationship by a merchant according to an embodiment of the present invention;

FIG. 8 is a flow chart of canceling a goods ordering relationship by a mobile user according to an embodiment of the present invention;

FIG. 9 is a flow chart of periodical goods deduction according to an embodiment of the present invention;

FIG. 10 is a flow chart of sending SMS message to a mobile user by a merchant according to an embodiment of the present invention.

### DETAILED DESCRIPTION OF THE EMBODIMENTS

The present invention will be further detailed by mainly taking the mobile communication payment as an example.

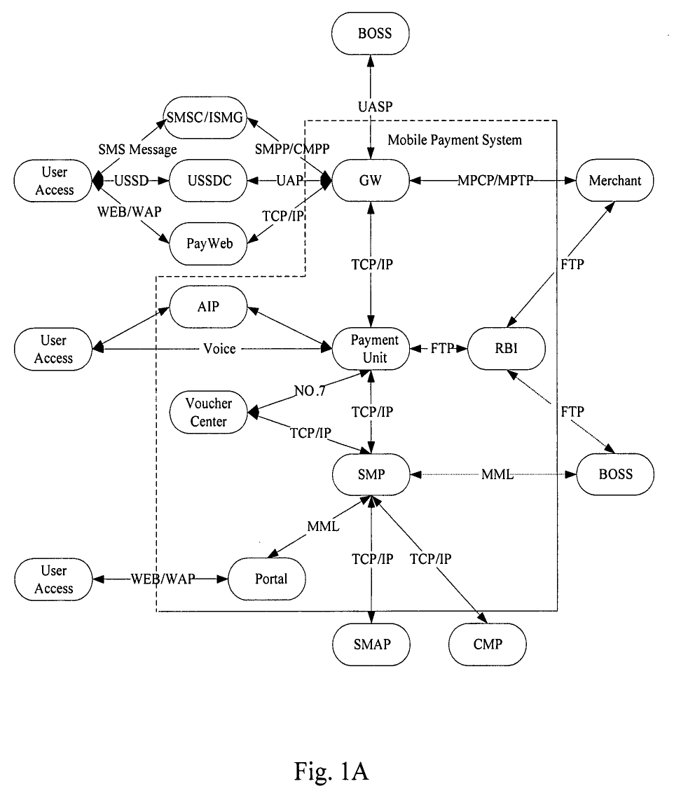

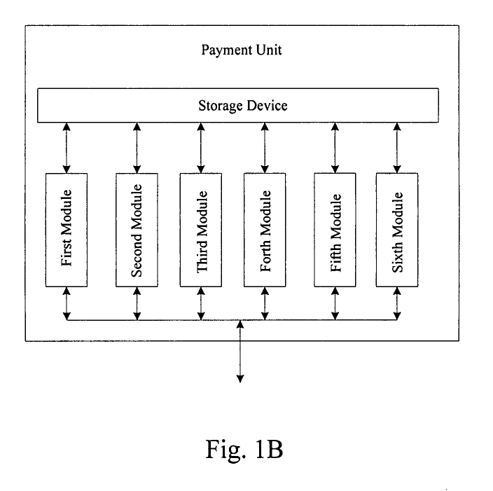

As shown in FIG. 1A, a mobile payment system includes:

a payment unit, which stores user data, merchant(or SP) information and goods information of merchants, etc., authenticates a transaction request issued by a mobile user, sends the transaction request passing through the authentication to a merchant, authenticates a payment request issued by the merchant and implements a payment service; the user data mainly includes: a user number, a payment password, balance of a payment account, daily consumption quota, monthly consumption quota, quota of a single consumption, and information regarding what periodical deduction goods from what merchants the user has ordered, etc.; and the goods information may include: a goods identifier, a goods name, a goods type, a goods unit price, a deduction type and a deduction period;

a gateway(GW), which is connected with the payment unit, implements the function of protocols conversion between the payment unit and an external system, triggers a payment procedure in the payment unit with TCP/IP protocol; and the GW provides various access modes for the mobile user and the merchant (SP) to access the payment unit;

an advanced intelligent peripheral(AIP), which is connected with the payment unit and provides a voice access mode for the mobile user through loading Voice extensible Makeup Language (VXML) scripts;

a service management point(SMP), which is connected with the payment unit, provides a management interface, via which a command is sent to the service management point to manage the user data in the payment unit; the managing of user data includes the operations of adding, modifying, and deleting the user data, etc.; the management interface provided by the service management point includes, but is not limited to, one or more of a man-machine language interface, a service management access point interface and a card number management platform(CMP) interface;

a voucher center, which is connected with the payment unit and the service management point, recharges a mobile user account in the payment unit under the control of the service management point; the CMP manages a rechargeable card used for payment via the service management point;

a portal, which is connected with the service management point, has the mobile user access the payment unit by means of providing Web pages and WAP; the mobile user and the merchant can log on the portal to perform management operations;

an unstructured supplementary service data center (USSDC), which is connected with the gateway, provides unstructured supplementary service data (USSD) access for the mobile user;

a record bill interface (RBI), which is connected with the payment unit and the merchant, provides a payment bill.

an Internet SMS Message Gateway (ISMG) and/or an SMS Center (SMSC), which is connected with the gateway, provides SMS message access for the mobile user.

As shown in FIG. 1B, as an example, the payment unit includes:

a storage device, which stores user data, merchant information and goods information of merchants;

a first module, which authenticates a transaction request issued by a mobile user to a merchant according to information in the storage device and sends the transaction request passing through the authentication to the merchant;

a second module, which receives a payment request generated by the merchant according to information of the transaction request, authenticates the payment request with the information in the storage device, notifies the mobile user to confirm the payment request after the payment request passes through the authentication, deducts from or denies deducting from account of the mobile user according to a confirmation result, and notifies a payment result to the mobile user and the merchant;

a third module, which receives an order canceling request issued by the merchant according to a request of canceling an order relationship from the mobile user and receives an order canceling request issued directly by the user, authenticates the order canceling request with the information in the storage device, cancels the order relationship in the storage device after the order canceling request passes through the authentication, and notifies the result to the mobile user and the merchant;

a forth module, which receives a premium distribution request issued by the merchant and authenticates the request with the information in the storage device, increases amount in the account of the user after the request passes through the authentication and notifies the result to the mobile user and the merchant, or denies the premium distribution request after the request fails to pass through the authentication and notifies the result to the merchant;

a fifth module, which receives a refundment request issued by the merchant and authenticates the request with the information in the storage device, increases amount in the account of the user after the request passes through the authentication and notifies the result to the mobile user and the merchant, or denies the refundment request after the request fails to pass through the authentication fails and notifies the result to the merchant;

a sixth module, which receives a reversal request issued by the merchant and authenticates the reversal request with the information in the storage device, reverses payment amount specified in the request after the request passes through the authentication, or denies the reversal request after the request fails to pass through the authentication and notifies the result to the mobile user and the merchant.

The first module marks a transaction request identifier in the information of the transaction request sent to the merchant; when the second module authenticates the payment request, the second module compares a transaction request identifier in the payment request with the transaction request identifier carried in the information of the transaction request to determine credibility of the payment request and thus avoids the merchant fraud.

If the payment request is a payment request for creating a new order relationship when the merchant identifies the goods specified in the transaction request is periodical deduction goods, the second module also establishes the order relationship in the storage device upon receiving the confirmation result of permitting the transaction from the mobile user; during a subsequent transaction after establishing the order relationship, the second module performs authentication with the order relationship when determining the payment request from the merchant is a periodical deduction request.

The SMS message, USSD, and WEB requests of the mobile user are unitedly forwarded to the payment unit via the gateway; the service management point provides a PayWeb via a Portal and the mobile user, the merchant and the administrator can realize self-management via the portal network. The payment unit performs service application by using an AIP device to load VXML scripts.

In the embodiments of the present invention, the payment unit can be either a Service Control Point (SCP) in an intelligent network or a separately arranged Micro Payment Platform (MPP). The merchant and the Business Operation Support System (BOSS) interact with the payment unit via the gateway; the payment unit defines a standard protocol to establish the basis of the session with the merchant, thus realizing an interaction with the merchant; the standard protocol includes, but is not limited to, the Micro Payment Communication Protocol (MPCP) and the Micro Payment Transaction Protocol (MPTP).

Hereafter, taking the MPP as the payment unit, the implementation of various operations will be detailed with reference to the drawings.

I. Service Procedure of a Payment Transaction

Payment modes provided by the payment unit (MPP) mainly include: SMS message, WEB, voice, USSD and WAP, etc. In a payment transaction, the merchant-side service procedures of different payment modes are the same, and difference lies in the payment modes between the user and the MPP. The transaction request, the confirmation information and the transaction result notification between the user and the MPP can use various modes of SMS message, voice, USSD, WEB or WAP, etc. according to different payment modes.

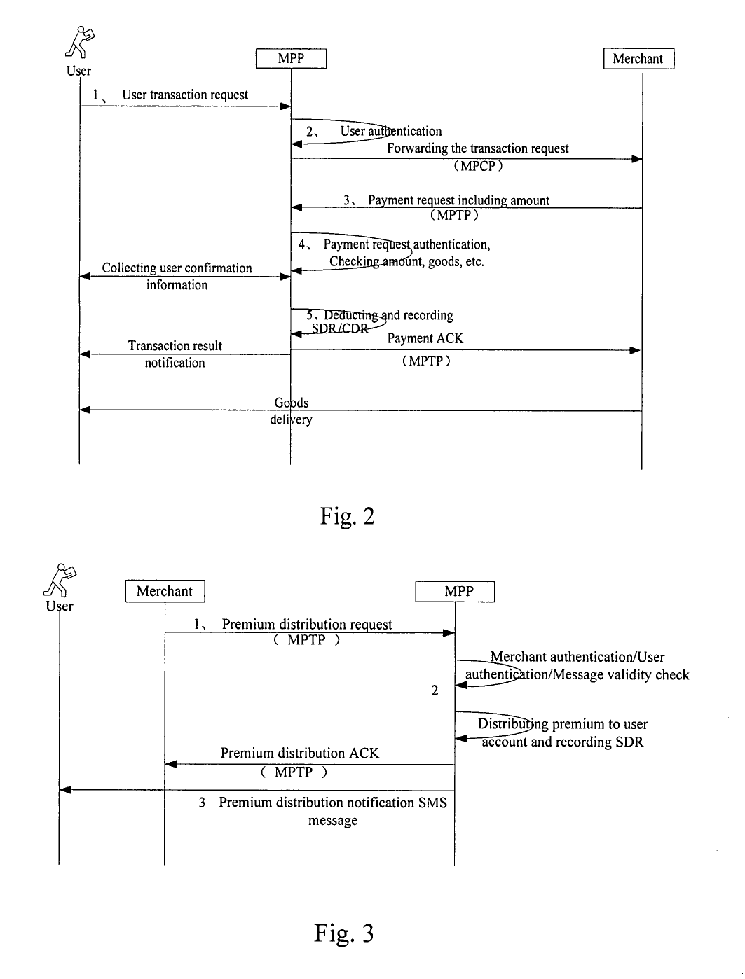

As shown in FIG. 2, the main procedure of a payment transaction is as follows:

1. A user issues a transaction request, and the transaction request includes information of transaction content of goods.

2. An MPP authenticates the transaction request; if the request passes through the authentication, the MPP forwards the transaction request to the merchant; otherwise, the MPP directly denies the transaction request.

3. The merchant generates a payment request according to the transaction content of the goods in the transaction request, and sends the payment request to the MPP; information of the payment request may include merchant information (merchant code), transaction detail information (goods code, quantity), payment mode, total transaction amount and transaction remark, and the payment request may contain more or fewer information.

4. The MPP authenticates the payment request sent by the merchant; if the request passes through the authentication, the MPP sends the payment request to the user issuing the transaction request for confirmation.

During an effective period of the transaction request, the user performs the payment confirmation of the transaction. The confirmation modes include: voice, SMS message, USSD, WEB and WAP. The voice mode is a mode of using telephone voice to confirm. The SMS message mode is a mode of sending confirmation message by the user. The USSD mode is a mode of directly inputting yes/no by the user to confirm. The WEB mode is a mode of inputting payment password and confirmation code (the confirmation code is sent to the mobile phone of the user) on the payment page by the user. The WAP mode is a mode of directly inputting payment password on the payment page by the user to confirm.

5. The MPP determines whether to deduct from a payment account of the mobile user according to a payment confirmation result of the mobile user; if the payment confirmation result of the mobile user is “permit”, the MPP deducts from the payment account of the mobile user, generates a Service Detail Record (SDR) of the payment transaction, which may includes the information of the transaction request and the payment confirmation result; otherwise, the payment unit denies to deduct from the payment account of the mobile user; the MPP sends a payment result to the merchant and notifies the payment result to the user by means of SMS message or other modes.

6. The merchant determines whether to provide service or goods for the user according to the payment result and notifies a transaction confirmation result to the user by means of SMS message or other modes. If the transaction confirmation result is “permit”, the merchant notifies the user to obtain the goods.

II. Service Procedure of Distributing Premium to a Mobile User by a Merchant

The MPP provides a function of distributing premium to a user who wins in a lottery service provided by the merchant; the merchant can directly distribute the premium to the account of the user who wins in the lottery service. As shown in FIG. 3, the main procedure is as follows:

1. The merchant generates a premium distribution request, the information of which may include merchant information (merchant code), distribution amount, winning user and remark.

2. The MPP authenticates the premium distribution request according to the information of the premium distribution request to determine whether to distribute premium to a payment account of the user and generates a premium distribution SDR bill (unique) as the basis of distribution audit.

3. The MPP sends a premium distribution result to the merchant and notifies the distribution result (including an SDR bill number) to the user by means of SMS message or other modes.

III. Refunding to a Mobile User by a Merchant

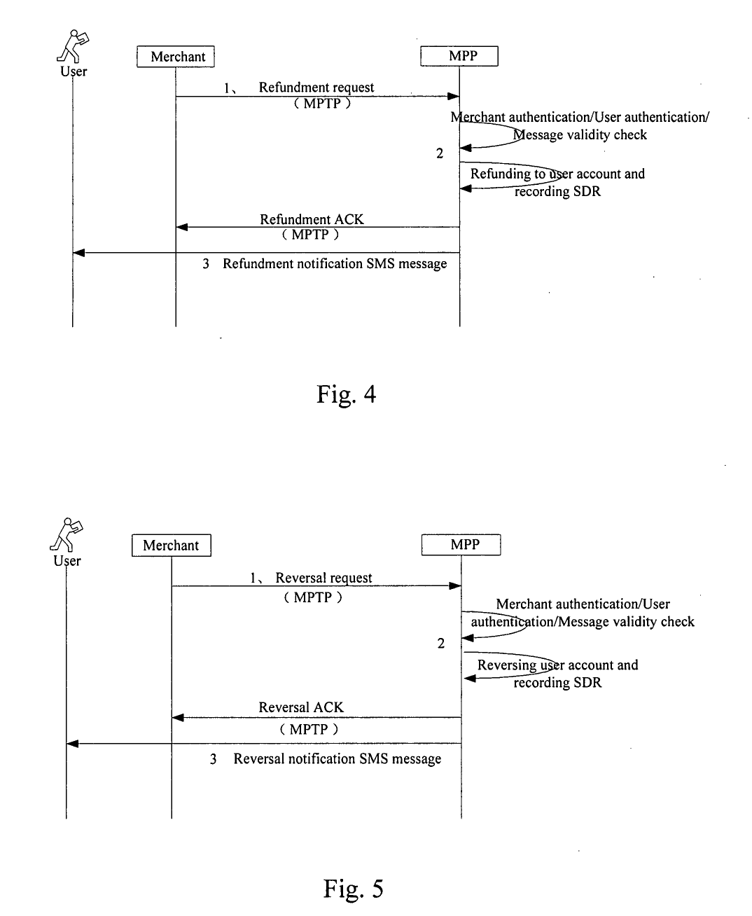

When the merchant has an error account of the previous day or the mobile user requires the merchant to refund, the merchant can use a refundment transaction to return the refundment to the user account. As shown in FIG. 4, the service procedure of the refundment is as follows:

1. The merchant generates a refundment request, the information of which may include a transaction code (unique), merchant information (merchant code), refundment amount, a refunded user and remark.

2. The MPP authenticates the refundment request according to the information of the refundment request to determine whether to refund to a payment account of the user and generates a refundment SDR bill (unique) as the basis of refundment audit according to the information of the refundment request.

3. The MPP sends a refundment result to the merchant and notifies the refundment result to the user (including an SDR bill number) by means of SMS message or other modes.

IV. Service Procedure of Reversing by a Merchant

When an intraday error account is found, the merchant can use a reversal function to reverse the transaction of the error account; a reversal request can reverse payments, premium distributions and refundments.

For a payment request with a new order mark, the reversing operation just reverses the payment amount and does not process the order relationship of the new order and the merchant should still retain the order relationship. For example, a user wants to purchase 3 monthly deduction goods and the total amount is 30 yuan. The merchant issues a payment request (with a new order mark) and succeeds. The MPP system deducts 30 yuan and establishes a goods order relationship whose number is 3 for the user. Later, the merchant reverses the transaction; the MPP system only refunds 30 yuan to the user and the goods order relationship whose number is 3 is unchanged. The merchant can initiate deduction again and continue to provide the service, or issue a request for canceling the order relationship.

As shown in FIG. 5, the service procedure of reversing by the merchant is as follows:

1. The merchant generates a reversal request, the information of which may include: transaction code (unique), merchant information (merchant code) and transaction code to be reversed (unique).

2. The MPP authenticates the reversal request according to the information of the reversal request to determine whether or not to reverse the transaction; if yes, the MPP processes the reversal according to the reversal request and generates a reversal SDR bill (unique).

3. The MPP sends a reversal result to the merchant, and notifies the reversal result to the user by means of SMS message or other modes.

V. Ordering and Canceling of Goods

Periodical deduction goods service is supplied only for a user with goods order relationship and a merchant can perform a payment deduction for such a user and with respect to the periodical deduction goods, the merchant can use a mobile terminated (MT) operation to send SMS message to the user with the goods order relationship.

The system extends an MPTP payment request instead of providing an order operation in the MPTP. Specifically, the system extends a new field identifier “whether or not a new order” in the MPTP payment request; if it is a new order, the MPP automatically establishes an order relationship between the user and the goods upon receiving confirmation from the user so that the merchant can unify the order action and the payment action.

In addition, the user having ordered the goods can directly issue a request for canceling the goods order relationship to the merchant, or cancel the goods order relationship by using a self-management function provided by the MPP.

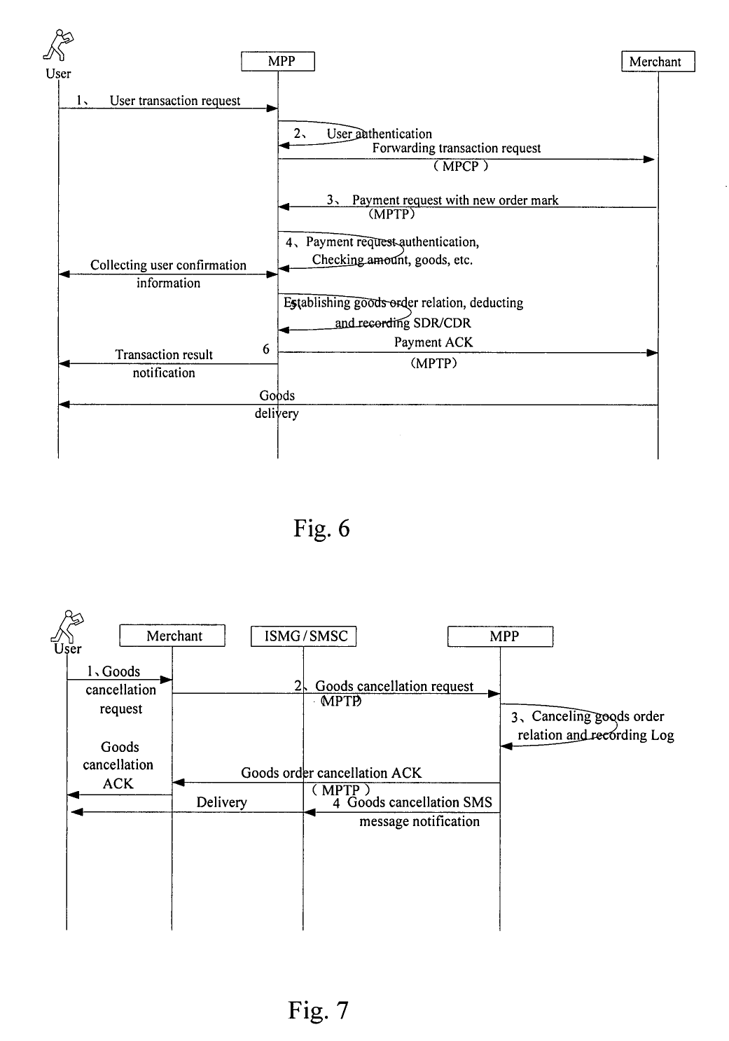

As shown in FIG. 6, the procedure of ordering goods is as follows:

1. The user issues a transaction request, the information of which may include transaction content of the goods;

2. The MPP authenticates the transaction request and forwards the transaction request to the merchant after the request passes through the authentication;

3. The merchant identifies that the goods mentioned in the information of the transaction request is periodical deduction goods (only when an order relationship of the periodical deduction goods is established in the MPP can the merchant initiate a deduction in every deduction period and can the deduction pass through the MPP authentication), and issues an MPTP payment request with a new order mark;

4. The MPP authenticates the payment request for creating a new order relationship issued by the merchant, and notifies the user to confirm after the request passes through the authentication;

5. If the user confirms the order of new goods, the MPP establishes the order relationship of the goods which records quantity of the ordered goods, performs a deduction process and records an SDR/CDR bill;

6. The MPP returns a payment acknowledgement to the merchant, and notifies a transaction result to the mobile user.

After the establishment of the order relationship, the merchant can initiate a periodical deduction transaction to the MPP and the mobile user can query the order relationship by means of MPP query channels.

As shown in FIG. 7, the procedure of issuing a request for canceling goods order relationship to the merchant by the mobile user is as follows:

1. The user sends a request for canceling order relationship of certain goods to the merchant.

2. The merchant generates an order canceling request and sends the order canceling request to the MPP; the information of the order canceling request may include: transaction code (unique), merchant information (merchant code), and code of the goods to be cancelled.

3. The MPP authenticates the merchant, the information of the order canceling request and the user; if the authentication succeeds, the MPP cancels the goods order relationship of the user.

4. The MPP returns an acknowledgement of canceling goods to the merchant, and notifies the mobile user by means of SMS message or other modes.

The user can query an order relationship by means of query channels provided by the MPP.

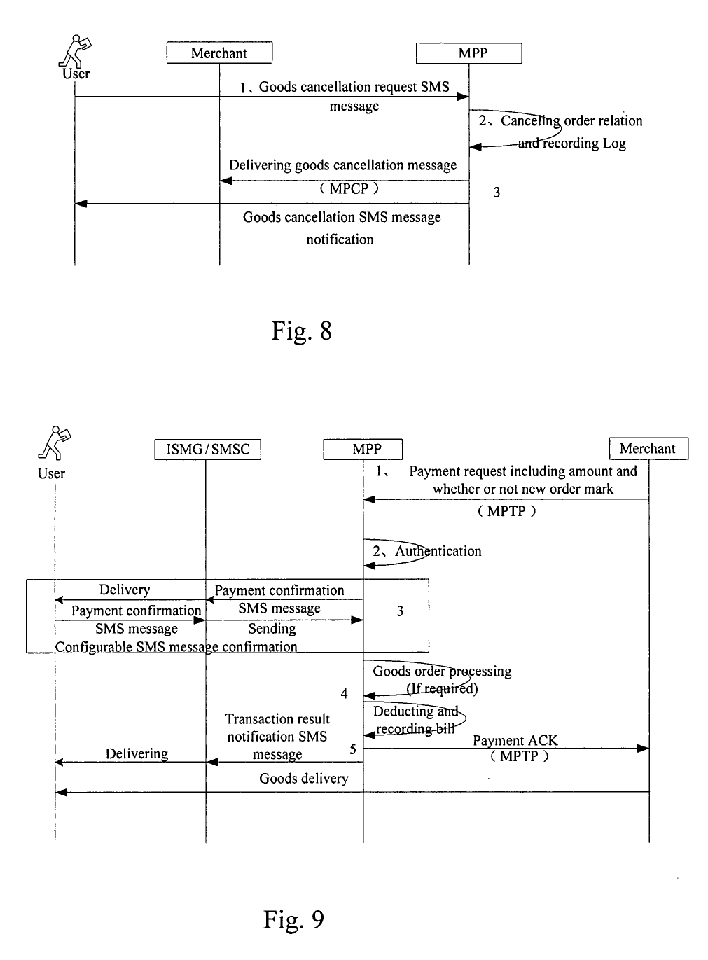

As shown in FIG. 8, the procedure of the user canceling goods order by using a self-management function of the MPP is as follows:

1. The user sends an order canceling request by means of SMS message or other modes;

2. The MPP authenticates the order canceling request of the user and cancels the goods order relationship of the user after the request passes through the authentication;

3. The MPP generates a message of canceling the goods, sends the message to the merchant as the basis of the user canceling the order and notifies the goods canceling result to the user by means of SMS message or other modes.

After the goods order relationship is cancelled, the merchant can not initiate to the MPP the periodical deduction transaction for the user again. The user can query order relationship by means of query channels provided by the MPP.

The merchant may periodically, such as monthly, require the MPP to update the goods order relationship data of users, i.e., require to transfer the user order data recorded in the MPP system to the service system of the merchant. The MPP provides monthly data files of the goods order relationship of the user according to the merchant, and stores the data files in the file interface directory of the MPP and the merchant for the merchant to download for local query and processing.

VI. Periodical Goods Deduction

After the user orders the periodical deduction goods, the merchant can use the function to issue the MPP a periodical deduction transaction request for the user.

The period of the periodical deduction goods may be 4 types of fixed periods: monthly, quarterly, biannually, and annually, independent of the user order date, i.e., if the goods deduction period is biannually, the current deduction periods of the user ordering in January and the user ordering in May both end on June 30, and the setting of period may be default or chosen by users.

As shown in FIG. 9, the service procedure of periodical deduction transaction of goods is as follows:

1. The merchant generates a periodical deduction request, the information of which may include merchant information (merchant code), transaction detail information (goods code, quantity), total transaction amount, a new order or not, and transaction remark, and sends the periodical deduction request to the MPP.

2. The MPP authenticates the merchant, the information of the periodical deduction request and the user.

Content of the authentication may include: payment quota check, balance check, authenticating the merchant and the goods, checking whether it is periodical deduction goods, checking whether there is order relationship with the goods and whether the deduction number of the present period exceeds the order number. Because the user may order several identical goods, the merchant can deduct several times and in batches with respect to the total quantity of goods order of the user. Therefore, the MPP should check the number of deduction of the merchant to ensure the total deduction number in the present deduction period does not exceed the order number of the user.

3. After the authentication succeeds, the MPP sends a payment confirmation notification to the mobile user and the user returns a confirmation result to the MPP.

4. The MPP determines whether or not to deduct from the user payment account according to the confirmation result and if yes, the MPP generates a payment SDR bill (unique), which includes the information of the periodical deduction request, etc.

5. The MPP sends a payment result to the merchant and notifies the payment result (including an SDR bill number) to the user by means of SMS message or other modes.

The merchant determines whether or not to provide service or goods for the user according to the payment result and if yes, the merchant notifies the transaction confirmation result to the user by means of SMS message or other modes, i.e., notifies the user to obtain the goods.

VII. Sending SMS Message to a User by a Merchant

The merchant can use a SUBMIT operation of MPCP to send SMS message to the user via the MPP system and obtain an SMS message status report. The merchant can send information goods (for example, account number and password of a point card, lottery number, etc. purchased by the user) by means of SUBMIT.

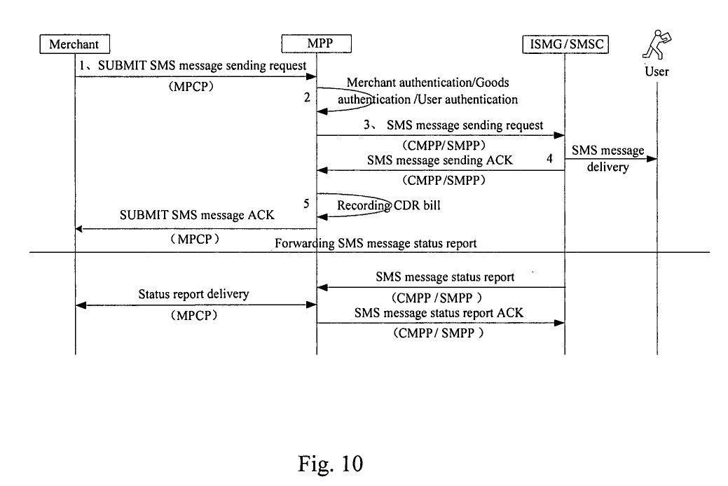

As shown in FIG. 10, the service procedure of sending SMS message to the user by the merchant is as follows:

1. The merchant generates a request for sending SUBMIT SMS message, the information of which may include merchant information (merchant code), user number, SMS message content, goods number, and sends the request to the MPP.

2. The MPP authenticates information of the request, such as the merchant, the user number and the goods information and determines whether to send the SMS message to the user according to the authentication result; the goods code information is carried in the SMS message; if the goods is periodical deduction goods, only when the user has the order relationship with the goods can the MPP allow the request to pass through the authentication.

3. After the request passes through the authentication, the MPP sends a request for delivering SMS message to an SMS message gateway.

4. The SMS message gateway delivers the SMS message to the user, and returns an SMS message delivery acknowledgement to the MPP.

5. The MPP generates a Communication Detail Record (CDR) bill, and returns an SMS message SUBMIT acknowledgement to the merchant.

The MPP provides a capability of reporting the SMS message status to the merchant. If the merchant requires a status report after the SMS message is sent, the MPP will obtain the SMS message status report reported by the SMS message center or the SMS message gateway, and send the SMS message status report to the merchant. The merchant can know whether the user receives the SMS message of goods delivery according to the status report; if the user does not receive the SMS message, the goods delivery is regarded as a failure and the merchant should initiate a reversal or a refundment operation (described in detail above) to return the transaction cost, or send an SMS message again.

Relying on the mobile network of operators and using the mobility and uniqueness of mobile phones, the payment unit of the embodiments of the present invention provides a new payment means for e-commerce. Mobile communication technologies are introduced to the payment mechanism of mobile e-commerce through associating the mobile phone number of the user with the payment account of the user. The terminal user can access the payment unit by means of voice, SMS message, WAP, Portal and USSD, etc. and perform the payment operation.

The mobile phone user can access the payment center by means of voice, SMS message, WAP, Portal and USSD to perform operations of payment, account transfer, account management, recharging, querying payment account balance, modifying password of payment account and querying transaction record, etc.

The merchant can send requests for payment, premium distribution, refundment, reversal, merchant service registration/cancellation, reconciliation and reconciliation result obtainment, etc., to the payment center. The mobile payment service center performs the specific operations and feeds the operation result back to the merchant.

The embodiments of the invention provide a mobile payment platform system for operators and provide a unified standard interface for the account operation management system of merchants and operators. The payment unit only needs to be constructed once to support and be adapted to various merchants and the access and development of service applications. Thus, it is not necessary for operators to construct a corresponding transaction payment system for each service application.

The embodiments of the present invention can construct a payment center by using intelligent network and thus provide a full-network, stable mobile payment center with high extensibility for operators.

While the present invention has been described with reference to examples of mobile communication and mobile users, the present invention is not limited to these. Using the above description, those skilled in the art can implement the payment method and system of the present invention in fixed communication networks without inventive labors. In fixed communication networks, the user can be a telephone terminal or a computer terminal, etc.

1. A payment system, comprising:
a payment unit, adapted for authenticating a transaction request issued by a user, sending the transaction request passing through the authentication to a merchant, authenticating a payment request issued by the merchant and processing payment service;
A gateway, connected with the payment unit and adapted for accessing the payment unit by the user and the merchant.

2. The payment system of claim 1, wherein the payment unit stores user data, merchant information and goods information of merchants, and the payment unit further comprises a service management point connected with the payment unit and adapted for providing a management interface and managing the user data, the merchant information and the goods information in the payment unit according to commands received from the management interface.

3. The payment system of claim 1, further comprising an intelligent peripheral connected with the payment unit and adapted for accessing, by the user, the payment unit by means of voice.

4. The payment system of claim 2, further comprising:
a voucher center, adapted for recharging an account of the user in the payment unit under the management of the service management point.

5. The payment system of claim 2, further comprising:
a portal connected with the service management point and adapted for accessing, by the user, the payment unit by means of providing Web pages and wireless application protocol (WAP).

6. The payment system of claim 1, further comprising:
an unstructured supplementary service data center (USSDC) connected with the gateway and adapted for providing supplementary service access for the user.

7. The payment system of claim 1, further comprising:
a record bill interface (RBI) connected with the payment unit and the merchant and adapted for providing a payment bill.

8. The payment system of claim 1, wherein the gateway provides SMS message access for the user through connecting with an Internet SMS Message Gateway (ISMG) and/or an SMS Center (SMSC), or provides Web pages and WAP access for the user.

9. The payment system of claim 2, wherein the management interface is one or more of a man-machine language interface, a service management access point interface and a card number management platform (CMP) interface.

10. The payment system of claim 2, wherein the payment unit comprises:
a storage device, adapted for storing the user data, the merchant information and the goods information of merchants;
a first module, adapted for authenticating the transaction request issued by the user according to contents stored in the storage device and sending the transaction request passing through the authentication to the merchant;
a second module, adapted for receiving the payment request issued by the merchant according to the transaction request, authenticating the payment request with the contents stored in the storage device, notifying the user to confirm the payment request after the payment request passes through the authentication, deducting from or denying deduction from an account of the user according to a confirmation result of the user, and notifying a payment result to the user and the merchant.

11. The payment system of claim 10, wherein the first module marks a transaction request identifier in the information of the transaction request sent to the merchant; when the second module authenticates the payment request, the second module compares a transaction request identifier in the payment request with the transaction request identifier carried in the information of the transaction request to determine credibility of the payment request and thus determine whether to continue the authentication.

12. The payment system of claim 10, wherein if the payment request is a payment request for generating a new order relationship when the merchant identifies goods specified in the transaction request is periodical deduction goods, the second module records the order relationship in the storage device upon receiving the confirmation result of permitting the transaction from the user; during a subsequent transaction after recording the order relationship, the second module authenticates with the order relationship when determining the payment request from the merchant is a periodical deduction request.

13. The payment system of claim 12, wherein the payment unit further comprises:
a third module, adapted for receiving an order canceling request issued by the merchant according to a request of canceling an order relationship from the user and receiving an order canceling request issued directly by the user, authenticating the order canceling request with the contents stored in the storage device, canceling the order relationship in the storage device after the order canceling request passes through the authentication, and notifying the result to the user and the merchant.

14. The payment system of claim 10, wherein the payment unit further comprises:
a forth module, adapted for receiving a premium distribution request issued by the merchant, authenticating the premium distribution request with the contents stored in the storage device, increasing amount in the account of the user after the premium distribution request passes through the authentication and notifies the result to the user and the merchant, or denying the premium distribution request after the premium distribution request fails to pass through the authentication and notifying the result to the merchant.

15. The payment system of claim 10, wherein the payment unit further comprises:
a fifth module, adapted for receiving a refundment request issued by the merchant, authenticating the request with the contents in the storage device, increasing amount in the account of the user after the request passes through the authentication and notifying the result to the user and the merchant, or denying the refundment request after the request fails to pass through the authentication and notifying the result to the merchant.

16. The payment system of claim 10, wherein the payment unit further comprises:
a sixth module, adapted for receiving a reversal request issued by the merchant, authenticating the reversal request with the contents in the storage device, reversing payment amount specified in the request after the request passes through the authentication or denying the reversal request after the request fails to pass through the authentication, and notifying the result to the user and the merchant.

17. A method for implementing mobile communication payment, comprising:
receiving, by a payment unit, a transaction request containing goods transaction content from a user;
authenticating the transaction request and sending the transaction request to a merchant after the request passes through the authentication;
receiving a payment request issued by the merchant according to the goods transaction content in the transaction request;
authenticating the payment request, requesting the user to confirm the payment request after the payment request passes through the authentication, and deducting from an account of the user upon receiving a confirmation of permitting the payment from the user.

18. The method of claim 17, further comprising: if the payment request is a payment request for generating a new order relationship when the merchant identifies that the goods specified in the transaction request is periodical deduction goods, deducting from the account of the user and recording the order relationship by the payment unit upon receiving the confirmation from the user.

19. The method of claim 18, further comprising: receiving an order canceling request issued by the merchant according to a request of canceling an order relationship from the user and receiving an order canceling request issued directly by the user; authenticating the order canceling request according to user data and the recorded order relationship, canceling the order relationship after the order canceling request passes through the authentication, and notifying the result to the user and the merchant.

20. The method of claim 18, further comprising: receiving a periodical deduction request from the user, authenticating the periodical deduction request according to user data and the recorded order relationship, deducting from the account of the user after the periodical deduction request passes through the authentication, and notifying the result to the user and the merchant.

21. The method of claim 18, further comprising: receiving a premium distribution request issued by the merchant, authenticating the premium distribution request according to information of the premium distribution request; increasing amount in the account of the user after the premium distribution request passes through the authentication, and notifying the result to the user and the merchant.

22. The method of claim 18, further comprising: receiving a refundment request issued by the merchant, authenticating the refundment request according to information of the refundment request; increasing amount in the account of the user after the refundment request passes through the authentication, and notifying the result to the user and the merchant.

23. The method of claim 18, further comprising: receiving a reversal request issued by the merchant, authenticating the reversal request according to information of the reversal request; reversing payment amount specified in the reversal request after the reversal request passes through the authentication, and notifying the result to the user and the merchant.

24. The method of claim 18, wherein the user accesses the payment unit by means of SMS message, voice, unstructured supplementary service data (USSD), Web pages or wireless application protocol (WAP).
